(19) United States
(12) Patent Application Publication
(10) Pub. No.: US 2025/0315736 A1
(43) Pub. Date: Oct. 9, 2025

(54) MODEL TRAINING METHOD AND APPARATUS

(71) Applicant: HUAWEI TECHNOLOGIES CO., LTD., Shenzhen (CN)

(72) Inventors: Fei WANG, Shanghai (CN); Chenghui PENG, Shanghai (CN); Jiaxun LU, Beijing (CN); Shuo WAN, Beijing (CN); Jianjun WU, Shenzhen (CN)

(73) Assignee: HUAWEI TECHNOLOGIES CO., LTD., Shenzhen (CN)

(21) Appl. No.: 19/244,333

(22) Filed: Jun. 20, 2025

Related U.S. Application Data
(63) Continuation of application No. PCT/CN2023/071944, filed on Jan. 12, 2023.

(51) Int. Cl. G06N 20/00; H04L 45/17

(52) U.S. Cl. CPC G06N 20/00; H04L 45/17

(57) ABSTRACT

A model training method and an apparatus relate to the field of communication technologies. This can reduce data transmission pressure and improve a training speed and training efficiency when a model is trained via each network node. The method includes: a first node updates an obtained first model to obtain an updated first model, and sends the updated first model to a next-hop node. The first node is any node in a node set, and the node set is used to train the first model. The updated first model converges on the first node. The next-hop node is a node in the node set.

### CROSS-REFERENCE TO RELATED APPLICATIONS

This application is a continuation of International Application No. PCT/CN2023/071944, filed on Jan. 12, 2023, the disclosure of which is hereby incorporated by reference in its entirety.

### TECHNICAL FIELD

Embodiments relate to the field of communication technologies, and to a model training method and an apparatus.

### BACKGROUND

With continuous development of communication technologies, a continuous attempt starts to be made to combine an artificial intelligence (AI) technology with a communication network, to implement model training and inference via the communication network.

For example, a model may be trained by using a federated learning algorithm. To be specific, the model may be distributed to each network node through a central server, and each network node performs model training and update, and uploads updated model/gradient data to the central server for aggregation, without uploading original data, so that data privacy is protected.

However, for the federated learning algorithm, a large amount of model/gradient data needs to be exchanged between the network node and the central server. As a scale of the model/gradient data becomes larger, data transmission of a wireless network encounters great pressure. In addition, network nodes at levels in the wireless network have strong heterogeneity, and have large differences in a computing capability, a memory, transmission bandwidth, and the like of the network nodes. A node with poor performance affects an overall training progress.

In this case, how to train the model via each network node to reduce data transmission pressure and improve a training speed and training efficiency becomes a problem to be urgently resolved.

### SUMMARY

Embodiments provide a model training method and an apparatus to reduce data transmission pressure and improve a training speed and training efficiency when a model is trained via each network node.

According to a first aspect, an embodiment provides a model training method. The method may include: a first node updates an obtained first model to obtain an updated first model, and sends the updated first model to a next-hop node. The first node is any node in a node set, and the node set is used to train the first model. The updated first model converges on the first node. The next-hop node is a node in the node set.

Based on the first aspect, when the first model is trained, a node in the node set may be used to train the first model, and the updated first model is sent to another node in the node set, to intelligently and flowingly train the first model by nodes in the node set, instead of being limited to training the first model by a single node, so that each node can obtain a result of updating and training the first model by another node. In addition, because a next-hop node of each node is a node in the node set, instead of a central server, this can reduce data transmission pressure, reduce transmission overheads, and reduce management and control complexity. Because each node sends the updated first model, instead of local original data, to the next-hop node, data privacy can be protected. In embodiments, heterogeneity of nodes can be further dynamically adapted to, thereby improving a training speed and training efficiency.

In a possible design or implementation, that the first node updates the first model to obtain the updated first model includes: the first node determines an activation parameter based on the first model and updates the activation parameter to obtain the updated first model. The activation parameter is a part or all of parameters of the first model.

Based on the possible design or implementation, when updating the first model, the first node may selectively update the part of the parameters of the first model, and freeze a remaining parameter (in other words, not update the remaining parameter), or the first node may update all of the parameters of the first model. This is not limited.

In a possible design or implementation, that the first node determines the activation parameter based on the first model includes: the first node determines the activation parameter based on one or more of the following: a data feature of the first node, a computing capability of the first node, or an update status of the parameters of the first model.

In a possible design or implementation, the activation parameter is a parameter that is in the parameters of the first model and whose correlation with data of the first node is greater than or equal to a preset threshold; the activation parameter is a parameter that has not been updated in the first model; or the activation parameter is any one or more parameters in the first model.

Based on the foregoing two possible designs or implementations, the first node may determine, as the activation parameter based on a data feature of local original data and a training target, a parameter with a strong correlation. Alternatively, the first node may determine, as the activation parameter, the parameter that has not been updated in the first model, so that complete traversal is performed for the first model as soon as possible, and impact on an update result of another node (for example, a node traversed for the first model before the first node) is reduced. Alternatively, the first node may alternatively randomly select one or more parameters in the first model as the activation parameter by using randomicity, to resolve a problem that a weight of a factor is excessively large in a fixed mode. In addition, implementation is simple, and no additional information needs to be collected. A plurality of possible solutions is provided for the first node to determine the activation parameter.

In a possible design or implementation, the first node determines the next-hop node based on node information of each node in the node set. The node information includes one or more of the following: first indication information, a data feature, a computing capability information, or channel state information. The first indication information indicates whether a node is traversed.

In a possible design or implementation, the next-hop node is a node that has not been traversed in the node set; the next-hop node is a node that is in the node set and whose correlation with the data of the first node is strongest; the next-hop node is a node that is in the node set and whose distance from the first node is shortest; the next-hop node is a node that is in the node set and that has highest connection power to the first node; the next-hop node is a node that is in the node set and whose computing capability is highest; or the next-hop node is any node in the node set.

Based on the foregoing two possible designs or implementations, a plurality of possible solutions is provided for the first node to determine the next-hop node. In addition, the first node determines the next-hop node in a fully self-organizing manner, to reduce management and control complexity.

In a possible design or implementation, that the first node sends the updated first model to the next-hop node includes: if a first condition is not met, the first node sends the updated first model to the next-hop node. The first condition is that a quantity of times that the first node is traversed is greater than or equal to a preset quantity of epochs, or the first condition is that model prediction accuracy of the first model is greater than or equal to preset accuracy.

Based on the possible design or implementation, when the first condition is not met, the first node may send the updated first model to the next-hop node, to continue training the first model. If the first condition is met, a model training process may end, to complete training of the first model.

In a possible design or implementation, each node in the node set is configured to update the first model in each epoch corresponding to the preset quantity of epochs.

Based on the possible design or implementation, in each epoch of traversal, each node in the node set may update the first model and send the updated first model to the next-hop node until the node set is completely traversed.

In a possible design or implementation, that the first node sends the updated first model to the next-hop node includes: the first node sends the updated first model to a plurality of next-hop nodes.

Based on the possible design or implementation, when sending the updated first model to the next-hop node, the first node may send the updated first model to the plurality of next-hop nodes, to obtain a plurality of final training results of the first model. This increases a degree of parallelism. In addition, each node can obtain migration of partial knowledge, to achieve a better effect than that achieved through independent training of the node.

According to a second aspect, an embodiment provides a communication apparatus. The communication apparatus may be used in the first node in the first aspect or the possible designs or implementations of the first aspect, to implement a function performed by the foregoing first node. The communication apparatus may be a first node, may be a chip or a system-a-on-chip configured to implement the function of the first node, or the like. The communication apparatus may implement the function performed by the first node by executing corresponding software by hardware. The hardware or the software includes one or more modules corresponding to the function, for example, a transceiver module and a processing module. The transceiver module is configured to obtain a first model. The processing module is configured to update the first model to obtain an updated first model. The transceiver module is further configured to send the updated first model to a next-hop node. The updated first model converges on the first node. The first node is any node in a node set, the node set is used to train the first model, and the next-hop node is a node in the node set.

In a possible design or implementation, the processing module is configured to: determine an activation parameter based on the first model; and update the activation parameter to obtain the updated first model. The activation parameter is a part or all of parameters of the first model.

In a possible design or implementation, the processing module is configured to determine the activation parameter based on one or more of the following: a data feature of the first node, a computing capability of the first node, or an update status of the parameters of the first model.

In a possible design or implementation, the activation parameter is a parameter that is in the parameters of the first model and whose correlation with data of the first node is greater than or equal to a preset threshold; the activation parameter is a parameter that has not been updated in the first model; or the activation parameter is any one or more parameters in the first model.

In a possible design or implementation, the processing module is further configured to determine the next-hop node based on node information of each node in the node set. The node information includes one or more of the following: first indication information, a data feature, computing capability information, or channel state information. The first indication information indicates whether a node is traversed.

In a possible design or implementation, the next-hop node is a node that has not been traversed in the node set; the next-hop node is a node that is in the node set and whose correlation with the data of the first node is strongest; the next-hop node is a node that is in the node set and whose distance from the first node is shortest; the next-hop node is a node that is in the node set and that has highest connection power to the first node; the next-hop node is a node that is in the node set and whose computing capability is highest; or the next-hop node is any node in the node set.

In a possible design or implementation, the transceiver module is configured to: if a first condition is not met, send the updated first model to the next-hop node. The first condition is that a quantity of times that the first node is traversed is greater than or equal to a preset quantity of epochs, or the first condition is that model prediction accuracy of the first model is greater than or equal to preset accuracy.

In a possible design or implementation, each node in the node set is configured to update the first model in each epoch corresponding to the preset quantity of epochs.

In a possible design or implementation, the transceiver module is further configured to send the updated first model to a plurality of next-hop nodes.

It should be noted that for a specific implementation of the communication apparatus in the second aspect, refer to a behavior function of the first node in the model training method provided in any one of the first aspect or the possible designs or implementations of the first aspect.

According to a third aspect, an embodiment provides a communication apparatus. The communication apparatus includes one or more processors. The one or more processors are configured to run a computer program or instructions. When the one or more processors execute computer program or the instructions, the communication apparatus is enabled to perform the model training method according to the first aspect.

In a possible design or implementation, the communication apparatus further includes one or more memories, the one or more memories are coupled to the one or more processors, and the one or more memories are configured to store the foregoing computer program or instructions. In a possible implementation, the memory is located outside the communication apparatus. In another possible implementation, the memory is located inside the communication apparatus. In this embodiment, the processor and the memory may alternatively be integrated into one component. In other words, the processor and the memory may alternatively be integrated together. In a possible implementation, the communication apparatus further includes a transceiver. The transceiver is configured to receive information and/or send information.

In a possible design or implementation, the communication apparatus further includes one or more communication interfaces, the one or more communication interfaces are coupled to the one or more processors, and the one or more communication interfaces are configured to communicate with a module other than the communication apparatus.

According to a fourth aspect, an embodiment provides a communication apparatus. The communication apparatus includes an input/output interface and a logic circuit. The input/output interface is configured to input and/or output information. The logic circuit is configured to: perform the model training method according to the first aspect; and perform processing based on information and/or generate information.

According to a fifth aspect or implementation, an embodiment provides a non-transitory computer-readable storage medium. The non-transitory computer-readable storage medium stores computer instructions or a program. When the computer instructions or the program is run on a computer, the model training method according to the first aspect is performed.

According to a sixth aspect, an embodiment provides a computer program product including computer instructions. When the computer program product runs on a computer, the model training method according to the first aspect is performed.

According to a seventh aspect, an embodiment provides a computer program. When the computer program is run on a computer, the model training method according to the first aspect is performed.

For effects brought by any one of the design manners of the third aspect to the seventh aspect, refer to at least the effects brought by the first aspect.

According to an eighth aspect, an embodiment provides a communication system. The communication system may include a first node and a next-hop node of the first node. The first node is configured to: obtain a first model; and update the first model to obtain an updated first model. The first node is any node in a node set, and a node in the node set is configured to train the first model. The updated first model converges on the first node. The first node is further configured to send the updated first model to the next-hop node. The next-hop node is a node in the node set. The next-hop node of the first node is configured to receive the updated first model from the first node.

In a possible design or implementation, the first node is configured to: determine an activation parameter based on the first model, where the activation parameter is a part or all of parameters of the first model; and update the activation parameter to obtain the updated first model.

In a possible design or implementation, the first node is configured to determine the activation parameter based on one or more of the following: a data feature of the first node, a computing capability of the first node, or an update status of the parameters of the first model.

In a possible design or implementation, the activation parameter is a parameter that is in the parameters of the first model and whose correlation with data of the first node is greater than or equal to a preset threshold; the activation parameter is a parameter that has not been updated in the first model; or the activation parameter is any one or more parameters in the first model.

In a possible design or implementation, the first node is further configured to determine the next-hop node based on node information of each node in the node set. The node information includes one or more of the following: first indication information, a data feature, computing capability information, or channel state information. The first indication information indicates whether a node is traversed.

In a possible design or implementation, the next-hop node is a node that has not been traversed in the node set; the next-hop node is a node that is in the node set and whose correlation with the data of the first node is strongest; the next-hop node is a node that is in the node set and whose distance from the first node is shortest; the next-hop node is a node that is in the node set and that has highest connection power to the first node; the next-hop node is a node that is in the node set and whose computing capability is highest; or the next-hop node is any node in the node set.

In a possible design or implementation, the first node is configured to: if a first condition is not met, send the updated first model to the next-hop node. The first condition is that a quantity of times that the first node is traversed is greater than or equal to a preset quantity of epochs, or the first condition is that model prediction accuracy of the first model is greater than or equal to preset accuracy.

In a possible design or implementation, each node in the node set is configured to update the first model in each epoch corresponding to the preset quantity of epochs.

In a possible design or implementation, the first node is configured to send the updated first model to a plurality of next-hop nodes.

For effects brought by any one of the design or implementation manners of the eighth aspect, refer at least to the effects brought by the first aspect.

### BRIEF DESCRIPTION OF DRAWINGS

FIG. 1a is a diagram of a communication system according to an embodiment;

FIG. 1b is a diagram of a communication system according to an embodiment

FIG. 2 is a diagram of composition of a communication apparatus according to an embodiment;

FIG. 3 is a diagram of a model training method according to an embodiment;

FIG. 4 is a flowchart of a model training method according to an embodiment 0

FIG. 5 is a flowchart of a model training method according to an embodiment;

FIG. 6 is a diagram of task parallelism according to an embodiment;

FIG. 7 is a diagram of a model training method according to an embodiment;

FIG. 8 is a diagram of a communication apparatus according to an embodiment; and

FIG. 9 is a diagram of composition of a communication apparatus according to an embodiment.

### DETAILED DESCRIPTION OF EMBODIMENTS

With continuous development of communication technologies, a continuous attempt starts to be made to combine an artificial intelligence (AI) technology of big data and a communication network (for example, perform federated learning between network data analytics functions (NWDAFs)), to implement model training and inference via the communication network.

A federated learning algorithm is used as an example. A model may be distributed to each network node (or described as a data node, a node, or the like) through a central server, and each network node performs model training and update, and uploads updated model/gradient data to the central server for aggregation, without uploading original data, so that data privacy is protected.

However, for the federated learning algorithm, a large amount of model/gradient data needs to be exchanged between a network node and the central server. As a scale of the model/gradient data becomes larger (for example, a size of a VGG16 model is 552 M, a vision transformer is of more than 1,337 MB+, and a parameter even breaks through a trillion level), data transmission of a wireless network encounters great pressure.

In addition, different from an internet technology (IT) network, network nodes at levels in the wireless network have strong heterogeneity, and have large differences in a computing capability, a memory, and transmission bandwidth of the network nodes. As a result, when the federated learning algorithm is applied, a serious straggler problem may occur, for example, a network node with poor performance executes a task slowly, affecting an overall federation progress.

In this case, how to train the model via each network node to reduce data transmission pressure and improve a training speed and training efficiency becomes a problem to be urgently resolved.

To resolve the foregoing problem, embodiments provide a model training method. In the method, a first node may update an obtained first model to obtain an updated first model, and send the updated first model to a next-hop node. The first node is any node in a node set, and the node set is used to train the first model. The updated first model converges on the first node. The next-hop node is a node in the node set.

The model training method provided in embodiments is a distributed learning method that is more suitable for use in a wireless network. When the first model is trained, a node in the node set may be used to train the first model, and the updated first model is sent to another node in the node set, to intelligently and flowingly train the first model by nodes in the node set, instead of being limited to training the first model by a single node, so that each node can obtain a result of updating and training the first model by another node. In addition, because a next-hop node of each node is a node in the node set, instead of a central server, this can reduce data transmission pressure, reduce transmission overheads, and reduce management and control complexity. Because each node sends the updated first model, instead of local original data, to the next-hop node, data privacy can be protected. In embodiments, heterogeneity of nodes can be further dynamically adapted to, thereby improving a training speed and training efficiency.

The following describes implementations of embodiments in detail with reference to accompanying drawings.

A model training method provided in embodiments may be applied to any communication system. The communication system may be a 3rd generation partnership project (3GPP) communication system, for example, a long term evolution (LTE) system, may be a 5th generation (5G) mobile communication system, a new radio (NR) communication system, a 5G-NR communication system, or a new radio vehicle to everything (NR V2X) system, may be applied to an LTE and 5G hybrid networking system, or a non-terrestrial network (NTN) system, a device-to-device (D2D) communication system, a machine to machine (M2M) communication system, an internet of things (IoT), an IT system, or another next generation communication system, for example, a future communication system like 6G, or may be a non-3GPP communication system. This is not limited.

Embodiments may be further applied to one or more of the following service scenarios: an enhanced mobile broadband (eMBB) service, ultra-reliable and low-latency communication (URLLC), machine-type communication (MTC), massive machine-type communication mMTC), narrowband internet of things (NB-IoT), customer premises equipment (CPE), augmented reality/virtual reality (AR/VR), V2X, and the like. This is not limited.

The eMBB is further improvement of performance such as user experience on the basis of a mobile broadband service scenario, and is also an application scenario closest to daily life. Most intuitive experience of 5G in this aspect is that a network speed is greatly improved. Even for watching a 4K high-definition video, a peak can reach 10 Gbps. For example, the eMBB may be a heavy-traffic mobile broadband service like a three-dimensional (3D) video/an ultra-high-definition video.

Features of the URLLC may include high reliability, low latency, and extremely high availability. The URLLC may include the following scenarios and applications: industrial application and control, traffic safety and control, remote manufacturing, remote training, remote surgery, and the like. The URLLC has a potential in a self-driving service. In addition, the URLLC is also very important for a security protection industry. For example, the URLLC may be a service that needs low-latency and high-reliable connections, for example, self-driving and industrial automation.

The MTC may also be referred to as M2M. The MTC features low costs, coverage enhancement, and the like.

The NB-IoT features wide coverage, numerous connections, a low rate, low costs, low power consumption, an excellent architecture, and the like, for example, massive connections, lower power consumption, and lower chip costs. For example, the NB-IoT is applied to a smart water meter, smart parking, smart pet tracking, a smart bicycle, a smart smoke detector, a smart toilet, and a smart vending machine.

The CPE is a mobile signal access device that receives a mobile signal and forwards the mobile signal by using a wireless-fidelity (Wi-Fi) signal, is also a device that converts a high-speed 4G or 5G signal into a Wi-Fi signal, and can support a large quantity of mobile terminals that simultaneously access a network. The CPE can be widely used in rural areas, towns, hospitals, organizations, factories, residential units, and the like for wireless network access, to reduce costs of wired network deployment.

The V2X is a key technology for a future intelligent transportation system. The V2X can enable communication between vehicles, between a vehicle and a base station, and between base stations. In this way, a series of traffic information such as a real-time road condition, road information, and pedestrian information can be obtained. This improves driving safety, reduces congestion, improves traffic efficiency, provides in-vehicle infotainment information, and the like.

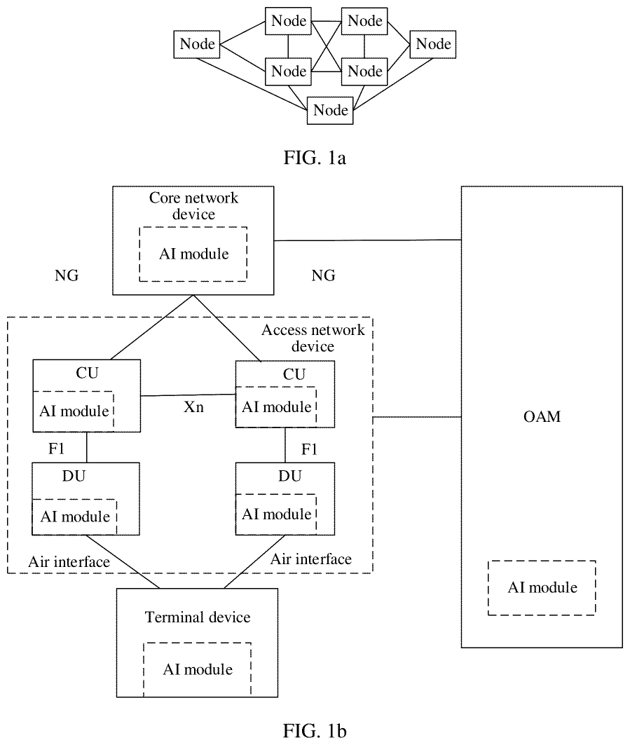

The following uses FIG. 1a as an example to describe the communication system provided in embodiments.

FIG. 1a is a diagram of a communication system according to an embodiment. As shown in FIG. 1a, the communication system may include a plurality of nodes (or described as network nodes, data nodes, apparatuses, communication apparatuses, devices, communication devices, or the like).

The node in FIG. 1a may be a device that can train and update a model.

An AI model is used as an example. Each node in FIG. 1a may be a device having an AI computing capability.

For example, each node may include an AI module, and each node may implement AI model inference through the AI module.

Optionally, each node in FIG. 1a may be any one of the following: a terminal device, an access network device, a core network device, a server, and the like. This is not limited.

The terminal device may be a device having a wireless transceiver function, or a chip or a chip system that may be disposed in the device, may allow a user to access a network, and is a device configured to provide voice and/or data connectivity for the user. The terminal device may be vehicle-mounted, portable, handheld, or the like. The terminal device and the user may be completely independent of each other. All user-related information may be stored in a smart card (SIM). The card may be used on the terminal device. The terminal device may complete direct interaction with an access network device through an air interface. The terminal device may send a signal and/or receive a signal.

The terminal device may also be referred to as user equipment (UE), a subscriber unit, a terminal, a mobile station (MS), a mobile terminal (MT), or the like. For example, the terminal device may be a cellular phone, a smartphone, a wireless data card, a mobile phone, a personal digital assistant (PDA) computer, a tablet computer or a computer having a wireless transceiver function, a wireless modem, a handheld device (handset), or a laptop computer. Alternatively, the terminal device may be a VR terminal, an AR terminal, a wireless terminal in industrial control, a wireless terminal in self-driving, a wireless terminal in telemedicine, a wireless terminal in a smart grid, a wireless terminal in a smart city, a wireless terminal in a smart home, an MTC terminal, a vehicle-mounted terminal, a vehicle having a vehicle-to-vehicle (V2V) communication capability, an intelligent connected vehicle, an uncrewed aerial vehicle having an uncrewed aerial vehicle to uncrewed aerial vehicle (U2U) communication capability, or the like. This is not limited.

The access network device may be any device that is deployed in an access network and that can perform wireless communication with a terminal device, and is responsible for all functions related to an air interface, such as a radio physical control function, a resource scheduling function, a radio access control function, a radio link maintenance function, a radio resource management function, and a mobility management function. The radio link maintenance function is to maintain a radio link with the terminal device, and is responsible for protocol conversion between radio link data and IP data. The radio resource management function includes radio link setup and release, radio resource scheduling and allocation, and the like. The mobility management function includes configuring a terminal device to perform measurement, evaluating quality of a radio link of the terminal device, making decisions on inter-cell handover of the terminal device, and the like.

For example, the access network device may be an access network (AN)/radio access network (RAN) device, and includes a plurality of AN/RAN nodes. The AN/RAN node may be an access point (AP), a base station (NB), a macro base station, a micro base station (or described as a small cell), a relay station, an enhanced base station (eNB), a next-generation eNB (ng-eNB), a next-generation base station (gNB), a transmission reception point (TRP), a transmission point (TP), a transmission measurement function (TMF), a wearable device, a vehicle-mounted device, another access node, or the like. This is not limited.

Alternatively, the access network device may be of a central unit (CU)/distributed unit (DU) architecture. In this case, the access network device may include two network elements: a CU and a DU. Alternatively, the access network device may be of a control plane-user plane (CP-UP) architecture. In this case, the access network device may include three network elements: a control plane of a CU (CU-CP), a user plane of the CU (CU-UP), and a DU. This is not limited. The access network device may further include a remote unit (RU). In different systems, the CU (or the CU-CP and the CU-UP), the DU, or the RU may also have different names, but a person skilled in the art may understand meanings of the names. For example, in an open radio access network (ORAN) system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in the embodiments. Any unit of the CU (or the CU-CP and the CU-UP), the DU, and the RU in the embodiments may be implemented by using a software module, a hardware module, or a combination of the software module and the hardware module.

Optionally, when the access network device is a CU (or an O-CU, a CU-CP, or a CU-UP), a DU (or an O-DU), or an RU (or an O-RU), the CU, the DU, or the RU may perform all sending and receiving operations performed by a node (a node such as a first node or another node) in the embodiments shown in FIG. 3 to FIG. 7 below, and/or configured to support another process of the technology described herein; and the CU, the DU, or the RU may also be configured to perform all operations other than sending and receiving operations performed by a node in the embodiments shown in FIG. 3 to FIG. 7 below, and/or configured to support another process of the technology described herein. This is not limited.

Optionally, when the access network device includes the CU, the DU, and the RU, the DU or the RU may perform all sending and receiving operations performed by a node (a node such as a first node or another node) in the embodiments shown in FIG. 3 to FIG. 7 below, and/or configured to support another process of the technology described herein; and the CU or the DU performs all operations other than sending and receiving operations performed by a node in the embodiments shown in FIG. 3 to FIG. 7 below, and/or configured to support another process of the technology described herein. This is not limited.

The core network device is responsible for providing a user connection, performing user management, and completing service bearing, and serves as a bearer network to provide an interface to an external network.

For example, the core network device may include network elements such as a mobility management network element, a session management network element, a user plane network element, and a session management network element. This is not limited.

The server may be deployed in a data network. The data network may be an operator network that provides a data transmission service for a user, for example, may be an operator network that provides an internet protocol multi-media service (IMS) for the user. This is not limited.

Optionally, as shown in FIG. 1b, nodes in a communication system may be connected to each other through an interface (for example, NG or Xn) or an air interface. One or more AI modules (only one AI module is shown in FIG. 1b for clarity) are disposed in one or more devices in these nodes, for example, a core network device, an access network device, a terminal device, or an operation, administration, and maintenance (OAM). The access network device may serve as an independent RAN node, or may include a plurality of RAN nodes, for example, include a CU and a DU. One or more AI modules may also be disposed in the CU and/or the DU. Optionally, the CU may be further split into a CU-CP and a CU-UP. One or more AI modules are disposed in the CU-CP and/or the CU-UP.

The AI module is configured to implement a corresponding AI function. AI modules deployed in different nodes may be the same or different. A model of the AI module is configured based on different parameters, and the AI module can implement different functions. The model of the AI module may be configured based on one or more of the following parameters: a structure parameter (for example, at least one of a quantity of neural network layers, a neural network width, a connection relationship between layers, a weight of a neuron, an activation function of a neuron, or a bias in an activation function), an input parameter (for example, a type of the input parameter and/or a dimension of the input parameter), or an output parameter (for example, a type of the output parameter and/or a dimension of the output parameter). The bias in the activation function may also be referred to as a bias of a neural network.

One AI module may have one or more models. One model may obtain one output through inference, where the output includes one or more parameters. Learning processes, training processes, or inference processes of different models may be deployed on different nodes or devices, or may be deployed on a same node or device.

It should be noted that each node in this embodiment may be one or more chips, or may be a system-on-a-chip (SoC) or the like. FIG. 1a is merely an example accompany drawing, and a quantity of devices included in FIG. 1a is not limited. In addition, in addition to the devices shown in FIG. 1a, the communication system may further include another device. Names of the devices and names of the links in FIG. 1a are not limited. In addition to the names shown in FIG. 1a, the devices and the links may have other names. This is not limited.

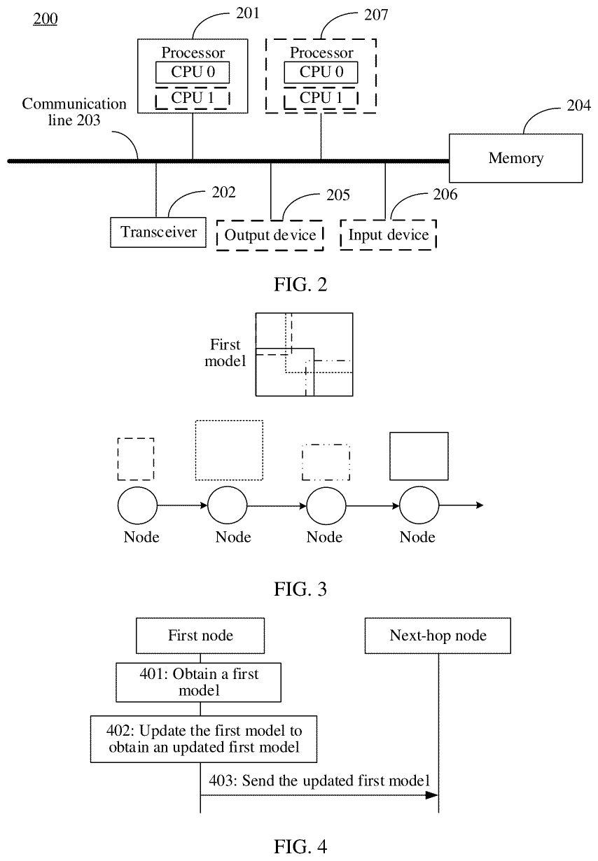

During specific implementation, each node shown in FIG. 1a may use a composition structure shown in FIG. 2, or include components shown in FIG. 2. FIG. 2 is a diagram of composition of a communication apparatus 200 according to an embodiment. The communication apparatus 200 may be a node, or a chip or a system-on-a-chip in the node. As shown in FIG. 2, the communication apparatus 200 includes a processor 201, a transceiver 202, and a communication line 203.

Further, the communication apparatus 200 may further include a memory 204. The processor 201, the memory 204, and the transceiver 202 may be connected through the communication line 203.

The processor 201 is a central processing unit (CPU), a general-purpose processor, a network processor (NP), a digital signal processor (DSP), a microprocessor, a microcontroller, a programmable logic device (PLD), or any combination thereof. Alternatively, the processor 201 may be another apparatus having a processing function, for example, a circuit, a component, or a software module. This is not limited.

The transceiver 202 is configured to communicate with another device or another communication network. The other communication network may be an Ethernet, a radio access network (RAN), wireless local area networks (WLAN), or the like. The transceiver 202 may be a module, a circuit, a transceiver, or any apparatus that can implement communication.

The communication line 203 is configured to transfer information between components included in the communication apparatus 200.

The memory 204 is configured to store instructions. The instructions may be computer programs.

The memory 204 may be a read-only memory (ROM) or another type of static storage device that can store static information and/or instructions, may be a random access memory (RAM) or another type of dynamic storage device that can store information and/or instructions, or may be an electrically erasable programmable read-only memory (EEPROM), a compact disc read-only memory (CD-ROM) or another compact disc storage, optical disc storage (including a compressed optical disc, a laser disc, an optical disc, a digital universal optical disc, a Blu-ray optical disc, and the like), a magnetic disk storage medium or another magnetic storage device, or the like. This is not limited.

It should be noted that the memory 204 may exist independently of the processor 201, or the memory 204 and the processor 201 may be integrated together. The memory 204 may be configured to store the instructions, program code, some data, or the like. The memory 204 may be located inside the communication apparatus 200, or may be located outside the communication apparatus 200. This is not limited. The processor 201 is configured to execute the instructions stored in the memory 204, to implement a model training method provided in the following embodiments.

In an example, the processor 201 may include one or more CPUs, for example, a CPU 0 and a CPU 1 in FIG. 2.

In an optional implementation, the communication apparatus 200 includes a plurality of processors. For example, in addition to the processor 201 in FIG. 2, the communication apparatus 200 may further include a processor 207.

In an optional implementation, the communication apparatus 200 further includes an output device 205 and an input device 206. For example, the input device 206 is a device like a keyboard, a mouse, a microphone, or a joystick, and the output device 205 is a device like a display or a speaker.

It should be noted that the communication apparatus 200 may be a desktop computer, a portable computer, a network server, a mobile phone, a tablet computer, a wireless terminal, an embedded device, a chip system, or a device having a similar structure in FIG. 2. In addition, the composition structure shown in FIG. 2 does not constitute a limitation on the communication apparatus. In addition to the components shown in FIG. 2, the communication apparatus may include more or fewer components than the components shown in the figure, combine some components, or have different component arrangements.

In this embodiment, the chip system may include a chip, or may include a chip and another discrete component.

In addition, actions, terms, and the like in this embodiment may be mutually referenced. This is not limited. In this embodiment, names of messages exchanged between the devices, names of parameters in the messages, or the like are merely examples. Other names may alternatively be used during specific implementation. This is not limited.

With reference to the communication system shown in FIG. 1a, training a first model is used as an example. A node set used to train the first model may be determined from nodes in the communication system.

The first model may be any to-be-trained model, the node set may include a plurality of nodes used to train the first model, and the node set may also be referred to as a coordinated set.

Optionally, the node set used to train the first model is determined based on a data type, a service type, a computing capability, and the like.

An example in which the first model is a model that is trained based on data of a service A is used. A plurality of nodes that execute the service A may be determined as the node set used to train the first model.

A scale of the node set may determine algorithm performance, where the algorithm performance is related to a computing capability, a data distribution feature, and the like of each node in the node set. For example, a higher computing capability of each node indicates better algorithm performance.

Optionally, when each node in the node set trains the first model, as shown in FIG. 3, the first model may be sequentially routed between the nodes in the node set, and each node updates a part or all of parameters of the first model based on local original data, and sends an updated first model to a next-hop node.

For example, refer to the following FIG. 4. A process in which each node updates the first model and sends the updated first model to the next-hop node is described in detail by using a first node as an example, where the first node may be any node in the node set, that is, any node in the node set may train the first model with reference to a method in the following FIG. 4, and send the updated first model to the next-hop node.

FIG. 4 is a flowchart of a model training method according to an embodiment. As shown in FIG. 4, the method may include the following steps.

Step 401: A first node obtains a first model.

The first node is any node in a node set, and the node set is used to train the first model.

Optionally, if the first node is a 1^{st} node that trains the first model, the first node may obtain the first model from an operation, administration, and maintenance (OAM), or the first model may be preset in the first node. If the first node is not a 1^{st} node that trains the first model, the first node may obtain the first model from a previous-hop node of the first node, that is, the first model obtained by the first node may be a first model updated by the previous-hop node.

Step 402: The first node updates the first model to obtain an updated first model.

That the first node updates the first model may also be described as that the first node trains the first model, and the updated first model may also be described as a trained first model.

That the updated first model converges on the first node may also be described as follows: the updated first model is in a converged state on the first node; the updated first model is a converged model on the first node; the first node trains the first model to a converged state; or the like. This is not limited.

Optionally, local original data of the first node serves as a data set, and the data set is randomly divided into a training set, a verification set, and a test set. The first model is updated (or described as trained) by using the training set, the first model is verified by using the verification set, the first model is continuously adjusted based on a verification result, and a final first model is evaluated by using the test set, to obtain the updated first model that reaches convergence.

For example, when accuracy of the test set reaches preset precision, it may be considered that the first model reaches convergence.

An example in which the preset precision is 95% is used. When the first node updates the first model, if the accuracy of the test set reaches 95%, the first node may consider that the updated first model reaches the converged state, so that updating of the first model is stopped and the updated first model is output.

Optionally, when updating the first model, the first node determines an activation parameter, and updates the activation parameter to obtain the updated first model.

The activation parameter may be a part or all of parameters of the first model, and the activation parameter may also be described as a weight parameter.

For example, the first node may selectively update the part of the parameters of the first model, and freeze a remaining parameter (or described as not update the remaining parameter), or the first node may update all of the parameters of the first model. This is not limited.

For example, the first node may determine the activation parameter based on one or more of the following: a data feature of the first node, a computing capability of the first node, or an update status of the parameters of the first model.

In a first possible implementation, the activation parameter may be a parameter that is in the parameters of the first model and whose correlation with data of the first node is greater than or equal to a preset threshold.

When the first model is updated, not all of the parameters are updated. The first node may determine, based on a data feature of the local original data and a training target, a parameter that plays a key role (or described as determine a parameter related to the data of the first node), and determine, as the activation parameter, the parameter that plays the key role.

For example, the first node may determine, as the activation parameter, the parameter that is in the first model and whose correlation with the data of the first node is greater than or equal to the preset threshold.

Optionally, the correlation between the parameter of the first model and the data of the first node is determined based on an information entropy.

For example, the information entropy may be a Fisher information entropy.

In a second possible implementation, the activation parameter is a parameter that has not been updated in the first model.

The first node may determine the activation parameter based on the update status of the parameters of the first model. For example, if a parameter or some parameters of the first model have been updated by another node, the first node may freeze the parameter or some parameters, and determine, as the activation parameter, a parameter that has not been updated. In this way, complete traversal can be performed for the first model as soon as possible, and impact on an update result of another node (for example, a node traversed for the first model before the first node) is reduced.

In a third possible implementation, the activation parameter is any one or more parameters in the first model.

The first node may alternatively randomly select one or more parameters in the first model as the activation parameter by using randomicity, to resolve a problem that a weight of a factor is excessively large in a fixed mode. In addition, implementation is simple, and no additional information (for example, a data feature and an update status of a model) needs to be collected.

In a fourth possible implementation, the first node determines the activation parameter based on the computing capability of the first node.

When the first node has a high computing capability, the first node may select a large quantity of parameters as the activation parameter. When the first node has a low computing capability, the first node may select a small quantity of parameters as the activation parameter. That is, the first node may flexibly perform self-adaption based on a computing resource of the first node (or may be described as dynamically adapt to heterogeneity of nodes), to avoid a straggler problem and improve a training speed and training efficiency.

The computing capability may be a computing processing capability of the first node. A higher computing processing capability indicates a higher computing capability.

For example, computing capability strength may be measured based on a quantity of CPUs included in the first node. For example, a larger quantity of CPUs included indicates a higher computing capability, and a smaller quantity of CPUs included indicates a lower computing capability.

Optionally, the first node may determine the activation parameter according to one or more of the first possible manner to the fourth possible implementation. This is not limited.

For example, the first node may select, from the parameter that has not been updated in the first model, the parameter whose correlation with the data of the first node is greater than or equal to the preset threshold, and determine the parameter as the activation parameter.

Optionally, when updating the activation parameter, the first node may calculate a gradient for the activation parameter, to update the activation parameter.

Optionally, the first node inputs a data sample (such as the local original data) into the first model for forward propagation, to obtain a loss function.

The loss function may also be referred to as a target loss function, a target function, or the like, and is used to evaluate a difference degree between a prediction value of the first model and a real value. A better loss function indicates better performance of the first model.

Optionally, the first node updates the activation parameter according to an anti-catastrophic forgetting algorithm, to avoid catastrophic forgetting caused by a case in which the updating of the first model by the first node overwrites an update result of the first model by a previous node.

For example, when the activation parameter is updated, some regular terms may be added to avoid excessively large update amplitude of a parameter that is largely associated with an old task (for example, updating of the first model by the previous node).

For example, when the activation parameter is updated, an elastic weight consolidation (EWC) algorithm may be used to avoid the catastrophic forgetting.

Optionally, when updating the first model, the first node may update the first model with reference to the following Formula (1):

$${M}^{n + 1} = f ( {M}^{n} , {D}^{n + 1} ) \qquad Formula ( 1 )$$

M indicates the first model, D indicates the local original data, and f indicates an update function, and may be an update function like continual learning, distillation, or aggregation. This is not limited.

Step 403: The first node sends the updated first model to a next-hop node.

The next-hop node may be a node in the node set.

In a possible design or implementation, the first node determines the next-hop node based on a uniformly pre-planned path.

After the node set is determined, training paths of the first model may be uniformly planned based on node information of nodes in the node set.

For example, the training paths may be uniformly planned by the nodes in the node set, the training paths may be uniformly planned by a control device in a network, or the training paths may be uniformly planned by a developer. This is not limited.

In another possible design or implementation, the first node determines the next-hop node in a fully self-organizing manner, to reduce management and control complexity.

For example, the first node may determine the next-hop node based on the node information of the nodes in the node set.

The node information may include one or more of the following: first indication information, a data feature, computing capability information, or channel state information. The first indication information indicates whether a node is traversed.

In a first possible implementation, the next-hop node is a node that has not been traversed in the node set.

The first node may determine, based on the first indication information, whether each node has been traversed, and select, as the next-hop node, a node that has not been traversed, so that complete traversal is performed for the first model in the node set as soon as possible.

In a second possible implementation, the next-hop node is a node that is in the node set and whose correlation with the data of the first node is strongest.

Because sequential training is performed on the first model, a data feature difference between two neighboring nodes affects a convergence effect of the first model, and oscillation may appear in a model convergence direction if the next-hop node is not properly selected. In this case, when the next-hop node is selected, a correlation degree between a data feature of each node and the data feature of the first node may be fully measured, and a node whose correlation is strongest is selected as the next-hop node.

For example, with reference to the following Formula (2) and Formula (3), a distance between data distributions may be calculated by using KL divergence, to represent a correlation between data:

$$q = {Min}_{q} D ( p ‖ q ) \qquad Formula ( 2 )$$

$$D ( p ‖ q ) = \int p ( x ) log \frac{p ( x )}{q ( x )} dx \qquad Formula ( 3 )$$

p indicates a sample distribution of the first node, and q indicates a sample distribution of another node. Larger KL divergence indicates a larger difference degree between the sample distribution of the first node and the sample distribution of the other node. Smaller KL divergence indicates a smaller difference degree between the sample distribution of the first node and the sample distribution of the other node.

In a third possible implementation, the next-hop node is a node that is in the node set and whose distance from the first node is shortest.

In consideration of data transmission latency and energy consumption, the next-hop node may be determined as the node that is in the node set and whose distance from the first node is shortest, to reduce the data transmission latency and the power consumption.

The foregoing distance may be a communication transmission distance between nodes, and a value of the communication transmission distance may be determined based on a value of the transmission latency. For example, lower transmission latency indicates a shorter communication transmission distance and a shorter distance from the first node. That is, the node whose distance from the first node is shortest may also be described as a node that has lowest transmission latency with the first node.

An example in which the first node is a base station is used. A next-hop node of the first node may be a neighboring base station.

In a fourth possible implementation, the next-hop node is a node that is in the node set and that has highest connection power to the first node.

In consideration of data transmission latency and energy consumption, the next-hop node may be determined, based on the channel state information, as the node that is in the node set and that has the highest connection power to the first node, to reduce the data transmission latency and power consumption.

For example, the first node may determine, based on the channel state information, a node with best channel quality as the node that is in the node set and that has the highest connection power to the first node.

In a fifth possible implementation, the next-hop node is a node that is in the node set and whose computing capability is highest.

Each node in the node set may update the part of the parameters of the first model based on a computing capability of the node. In this case, the first node may select, as the next-hop node, the node whose computing capability is highest, to train more parameters more quickly.

In a sixth possible implementation, the next-hop node is any node in the node set.

The first node may alternatively randomly select a node from the node set as the next-hop node by using randomicity, to resolve a problem that a weight of a factor is excessively large in a fixed mode. In addition, implementation is simple, and no additional information needs to be collected.

Optionally, the first node may determine the next-hop node according to one or more of the first possible implementation to the sixth possible implementation. That is, the first node may comprehensively consider a plurality of factors mentioned in the first possible implementation to the sixth possible implementation, to perform optimization under a multi-factor parametric value.

For example, the first node may mathematically analyze, in a mathematical modeling manner, impact of each factor (for example, one or more of whether to be traversed, a correlation, a node distance, a node computing capability, connection power, or a randomly selected node) on final model training, to perform optimal solution. This has strong interpretability.

For another example, the first node may alternatively use AI modeling. The first node uses a plurality of factors (for example, one or more of whether to be traversed, a correlation, a node distance, a node computing capability, connection power, or a randomly selected node) as an input feature, and performs modeling by using deep learning or reinforcement learning, to obtain a routing solution through learning. Implementation is simple.

According to the method shown in FIG. 4, when the first model is trained, a node in the node set may be used to train the first model, and the updated first model is sent to another node in the node set, to intelligently and flowingly train the first model by the nodes in the node set, instead of being limited to training the first model by a single node, so that each node can obtain a result of updating and training the first model by another node.

In addition, because a next-hop node of each node is a node in the node set, instead of a central server, frequent upload and download of model/gradient data in a federated learning algorithm are avoided, thereby greatly reducing communication overheads, reducing communication pressure, reducing data transmission pressure, and reducing transmission overheads. A decentralized training manner is used, so that a performance bottleneck and a security risk of the central server can be eliminated, any node in the node set can be replaced at any time when a problem occurs, training is not blocked, and the heterogeneity of the nodes can be dynamically adapted to, thereby improving a training speed and training efficiency, and reducing management and control complexity.

In addition, in a sequential routing manner, model training is performed between distributed nodes, and each node sends the updated first model, instead of the local original data, to the next-hop node, so that data privacy can be protected.

Based on the foregoing descriptions, optionally, when the first model is trained, each node in the node set may perform one or more epochs of traversal on the first model.

Optionally, in each epoch of traversal, each node in the node set participates in updating the first model, that is, each node in the node set is configured to update the first model in each epoch of traversal.

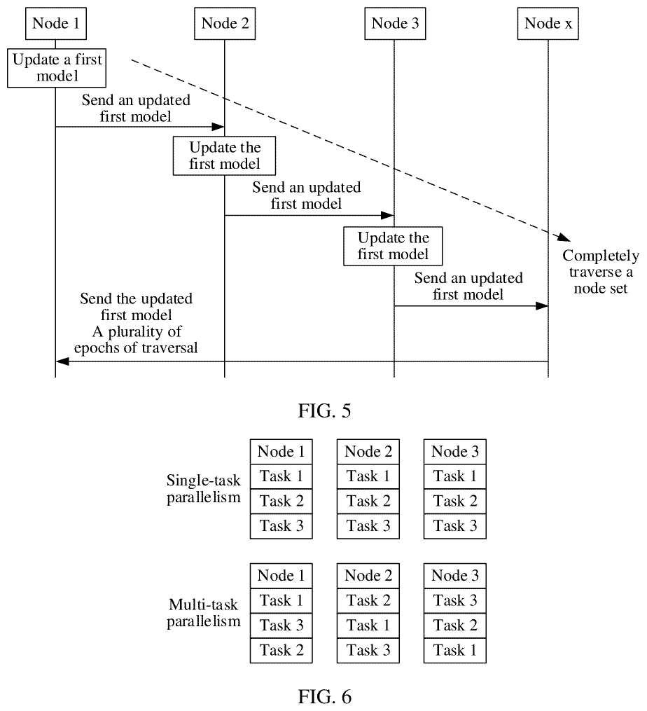

For example, as shown in FIG. 5, in each epoch of traversal, each node in a node set may perform the method shown in FIG. 4 to update a first model, and send an updated first model to a next-hop node until the node set is completely traversed.

Optionally, in each epoch of traversal, training paths of the first model between nodes may be different.

Optionally, when a first condition is not met, each node may send the updated first model to the next-hop node, to continue training the first model. If the first condition is met, a model training process may end, to complete training of the first model.

For example, the first condition may be that a quantity of times that a node is traversed is greater than or equal to a preset quantity of epochs.

That when the first condition is not met, each node sends the updated first model to the next-hop node, to continue training the first model may be replaced with the following descriptions: When the quantity of times that the node is traversed is less than or equal to the preset quantity of epochs, each node sends the updated first model to the next-hop node, to continue training the first model.

The first node is used as an example, and the first condition may be that a quantity of times that the first node is traversed is greater than or equal to the preset quantity of epochs.

For another example, the first condition may be that model prediction accuracy of the first model is greater than or equal to preset accuracy.

Optionally, nodes in the node set may simultaneously train a plurality of first models, to implement multi-task parallelism.

Because more than one task may run on each node in a network, in comparison with single-task parallelism, the multi-task parallelism may be implemented by simultaneously training the plurality of first models by nodes in the node set, thereby improving a training speed and training efficiency.

The single-task parallelism may mean that nodes execute a same task in a same period of time, and execute different tasks in different periods of time. The multi-task parallelism may mean that nodes may execute different tasks in a same period of time.

For example, as shown in FIG. 6, for single-task parallelism, a node 1, a node 2, and a node 3 may execute a task 1 in a first period of time, execute a task 2 in a second period of time, and execute a task 3 in a third period of time. For multi-task parallelism, a node 1 may execute a task 1 (for example, update a first model 1) in a first period of time, and send, to a node 2, a result of executing the task 1 by the node 1; the node 2 executes the task 1 in a second period of time, and sends, to a node 3, a result of executing the task 1 by the node 2; and the node 3 executes the task 1 in a third period of time. Alternatively, a node 2 may execute a task 2 (for example, update a first model 2) in a first period of time, and send, to a node 3, a result of executing the task 2 by the node 2; the node 3 executes the task 2 in a second period of time, and sends, to a node 1, a result of executing the task 2 by the node 3; and the node 1 executes the task 2 in a third period of time. Alternatively, a node 3 may execute a task 3 (for example, update a first model 3) in a first period of time, and send, to a node 1, a result of executing the task 3 by the node 3; the node 1 executes the task 3 in a second period of time, and sends, to a node 2, a result of executing the task 3 by the node 1; and the node 2 executes the task 3 in a third period of time.

Optionally, when sending an updated first model to a next-hop node, each node may send the updated first model to a plurality of next-hop nodes, to obtain a plurality of final training results of a first model. This increases a degree of parallelism. In addition, each node can obtain migration of partial knowledge, to achieve a better effect than that achieved through independent training of the node.

Obtaining the migration of the partial knowledge may mean that each node may obtain, through learning and based on an updated first model sent by a previous-hop node, updating of the first model by the previous node.

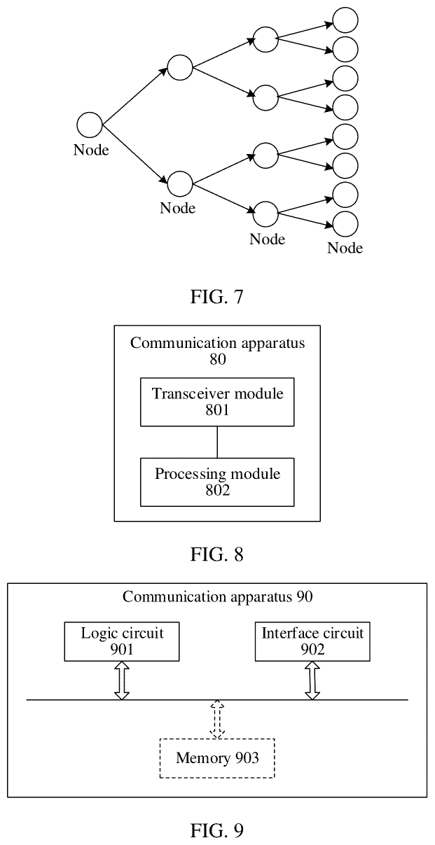

For example, as shown in FIG. 7, each node may send an updated first model to two next-hop nodes, to obtain eight training results.

Optionally, for a plurality of training results of a first model, a training result with highest prediction accuracy may be selected as a final training result of the first model, the plurality of training results may serve as different training results of the first model on different training paths, or the plurality of training results may be aggregated to obtain a final training result of the first model. This is not limited.

It should be noted that the methods provided in embodiments may be implemented separately, or may be implemented in combination. This is not limited.

It may be understood that, in embodiments, an execution body may perform a part or all of the steps in embodiments. These steps or operations are merely examples. In embodiments, another operation or variants of various operations may further be performed. In addition, the steps may be performed in a sequence different from a sequence presented in embodiments, and not all operations in embodiments need to be performed.

The foregoing describes the solutions provided in embodiments from a perspective of interaction between the devices. It may be understood that, to implement the foregoing functions, each device includes a corresponding hardware structure and/or a corresponding software module for performing each function. A person skilled in the art should easily be aware that, in combination with algorithms and steps in the examples described in embodiments described herein, the embodiments can be implemented by hardware or a combination of hardware and computer software. Whether a function is performed by the hardware or the hardware driven by the computer software depends on particular applications and design constraints of the solutions. A person skilled in the art may use different methods to implement the described functions for each particular application, but it should not be considered that the implementation goes beyond the scope of the embodiments.

In embodiments, the devices may be divided into functional modules based on the foregoing method examples. For example, each functional module may be obtained through division based on each corresponding function, or two or more than two functions may be integrated into one processing module. The integrated module may be implemented in a form of hardware, or may be implemented in a form of a software functional module. It should be noted that, in embodiments, module division is an example, and is merely a logical function division. During actual implementation, another division manner may be used.

When each functional module is obtained through division based on each corresponding function, FIG. 8 shows a communication apparatus 80. The communication apparatus 80 may perform actions performed by the first node in the methods shown in FIG. 3 to FIG. 7. All related content of steps in the foregoing method embodiments may be referenced to functional descriptions of corresponding functional modules. For effects that can be achieved by the communication apparatus 80, refer at least to the foregoing method embodiments. Details are not described herein again.

The communication apparatus 80 may include a transceiver module 801 and a processing module 802. For example, the communication apparatus 80 may be a communication device, or may be a chip used in the communication device, or another combined device or part that has a function of the communication apparatus. When the communication apparatus 80 is the communication device, the transceiver module 801 may be a transceiver, where the transceiver may include an antenna, a radio frequency circuit, and the like; and the processing module 802 may be a processor (or a processing circuit), for example, a baseband processor, where the baseband processor may include one or more CPUs. When the communication apparatus 80 is the part having the function of the communication apparatus, the transceiver module 801 may be a radio frequency unit; and the processing module 802 may be a processor (or a processing circuit), for example, a baseband processor. When the communication apparatus 80 is a chip system, the transceiver module 801 may be an input/output interface of a chip (for example, a baseband chip); and the processing module 802 may be a processor (or a processing circuit) of the chip system, and may include one or more central processing units. It should be understood that the transceiver module 801 in this embodiment may be implemented by the transceiver or a transceiver-related circuit component; and the processing module 802 may be implemented by the processor or a processor-related circuit component (or referred to as the processing circuit).

For example, the transceiver module 801 may be configured to perform all sending and receiving operations performed by the communication apparatus in the embodiments shown in FIG. 3 to FIG. 7, and/or configured to support another process of the technology described herein; and the processing module 802 may be configured to perform all operations other than the sending and receiving operations performed by the communication apparatus in the embodiments shown in FIG. 3 to FIG. 7, and/or configured to support another process of the technology described herein.

In another possible implementation, the transceiver module 801 in FIG. 8 may be replaced with a transceiver, and a function of the transceiver module 801 may be integrated into the transceiver. The processing module 802 may be replaced with a processor, and a function of the processing module 802 may be integrated into the processor. Further, the communication apparatus 80 shown in FIG. 8 may include a memory.

Alternatively, when the processing module 802 is replaced with the processor, and the transceiver module 801 is replaced with the transceiver, the communication apparatus 80 in this embodiment may be a communication apparatus 90 shown in FIG. 9. The processor may be a logic circuit 901, and the transceiver may be an interface circuit 902. Further, the communication apparatus 90 shown in FIG. 9 may include a memory 903.

An embodiment further provides a computer program product. When the computer program product is executed by a computer, a function of any one of the foregoing method embodiments may be implemented.

An embodiment further provides a computer program. When the computer program is executed by a computer, a function of any one of the foregoing method embodiments may be implemented.

An embodiment further provides a non-transitory computer-readable storage medium. All or a part of procedures in the foregoing method embodiments may be completed by a computer program instructing related hardware. The program may be stored in the foregoing non-transitory computer-readable storage medium. When the program is executed, the procedures in the foregoing method embodiments may be included. The non-transitory computer-readable storage medium may be an internal storage unit in the terminal (including a data transmit end and/or a data receive end) in any one of the foregoing embodiments, for example, a hard disk drive or a memory of the terminal. The non-transitory computer-readable storage medium may alternatively be an external storage device of the foregoing terminal, for example, a plug-connected hard disk drive, a smart media card (SMC), a secure digital (SD) card, and a flash card that are configured on the foregoing terminal. Further, the non-transitory computer-readable storage medium may further include both an internal storage unit of the foregoing terminal and an external storage device. The non-transitory computer-readable storage medium is configured to store the computer program and other programs and data required by the foregoing terminal. The non-transitory computer-readable storage medium may be further configured to temporarily store data that has been output or is to be output.

It should be noted that in the embodiments and accompanying drawings, the terms “first”, “second”, and the like are intended to distinguish between different objects, but are not intended to describe a particular sequence. “First” and “second” are merely intended for a purpose of description, and shall not be understood as an indication or implication of relative importance or implicit indication of a quantity of indicated features. Therefore, a feature limited by “first” or “second” may explicitly or implicitly include one or more features. In the descriptions of embodiments, unless otherwise specified, “a plurality of” means two or more than two.

In addition, the terms “include” and “have” and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

It should be understood that in the embodiments, “at least one (item)” means one or more. “A plurality of” refers to two or more than two. “At least two (items)” means two, three, or more than three. “And/or” is used to describe an association relationship between associated objects, and indicates that three relationships may exist. For example, “A and/or B” may indicate three cases: only A exists, only B exists, and both A and B exist, where A and B may be singular or plural. The character “/” generally indicates an “or” relationship between the associated objects. “At least one of the following items (pieces)” or a similar expression thereof means any combination of these items, including any combination of singular items (pieces) or plural items (pieces). For example, at least one of a, b, or c may indicate a, b, c, “a and b”, “a and c”, “b and c”, or “a, b, and c”, where a, b, and c may be singular or plural. Both “when . . . ” and “if” mean that corresponding processing is performed in an objective case, are not intended to limit time, do not require a determining action during implementation, and do not mean that there is another limitation.

In addition, in embodiments, the word “example” or “for example” indicates giving an example, an illustration, or a description. Any embodiment, design solution, or implementation described as the “example” or “for example” in embodiments should not be explained as being more preferred or having more advantages than another embodiment, design solution, or implementation. Further, use of the word like the “example” or “for example” is intended to present a related concept in a specific manner for ease of understanding.

Based on the foregoing descriptions of the implementations, a person skilled in the art may clearly understand that for convenient and brief descriptions, division into the foregoing functional modules is merely used as an example for descriptions. In actual application, the foregoing functions can be assigned to different functional modules for competition based on a requirement, that is, an inner structure of an apparatus is divided into different functional modules to complete all or a part of the functions described above.

In the several embodiments provided, it should be understood that the apparatus and method may be implemented in other manners. For example, the described apparatus embodiments are merely examples. For example, the module or division into the units is merely logical function division and may be other division during actual implementation. For example, a plurality of units or components may be combined or integrated into another apparatus, or some features may be ignored or not performed. In addition, the displayed or discussed mutual couplings or direct couplings or communication connections may be implemented through some interfaces. The indirect couplings or communication connections between the apparatuses or units may be implemented in an electrical form, a mechanical form, or another form.

The units described as separate parts may or may not be physically separate, and parts displayed as units may be one or more physical units, may be located in one place, or may be distributed on different places. A part or all of the units may be selected based on an actual requirement to achieve the objectives of the solutions of embodiments.

In addition, functional units in embodiments may be integrated into one processing unit, each of the units may exist alone physically, or two or more than two units are integrated into one unit. The integrated unit may be implemented in a form of hardware, or may be implemented in a form of a software functional unit.

When the integrated unit is implemented in the form of the software functional unit and sold or used as an independent product, the integrated unit may be stored in a readable storage medium, such as a non-transitory computer readable storage medium. Based on such understanding, the solutions in embodiments essentially or all or a part of the solutions may be implemented in a form of a software product. The software product is stored in a storage medium and includes several instructions for instructing a device (which may be a single-chip microcomputer, a chip or the like) or a processor to perform all or a part of the steps of the methods described in embodiments. The foregoing storage medium includes any medium that can store program code, like a USB flash drive, a removable hard disk, a ROM, a RAM, a magnetic disk, or an optical disc.

It should be appreciated that the embodiments described are some, but not all, embodiments. Further, any modification or variation made by a person of ordinary skill in the art shall fall within the scope of the embodiments.

1. A method, comprising:
obtaining, by a first node, a first model, wherein the first node is any node in a node set, and the node set is used to train the first model;
updating, by the first node, the first model to obtain an updated first model, wherein the updated first model converges on the first node; and
sending, by the first node, the updated first model to a next-hop node, wherein the next-hop node is a node in the node set.

2. The method according to claim 1, wherein updating, by the first node, the first model to obtain the updated first model comprises:
determining, by the first node, an activation parameter based on the first model, wherein the activation parameter is a part or all of parameters of the first model; and
updating, by the first node, the activation parameter to obtain the updated first model.

3. The method according to claim 2, wherein determining, by the first node, the activation parameter based on the first model comprises:
determining, by the first node, the activation parameter based on one or more of the following: a data feature of the first node, a computing capability of the first node, or an update status of the parameters of the first model.

4. The method according to claim 2, wherein
the activation parameter is a parameter that is in the parameters of the first model and whose correlation with data of the first node is greater than or equal to a preset threshold;
the activation parameter is a parameter that has not been updated in the first model; or
the activation parameter is any one or more parameters in the first model.

5. The method according to claim 3, wherein
the activation parameter is a parameter that is in the parameters of the first model and whose correlation with data of the first node is greater than or equal to a preset threshold;
the activation parameter is a parameter that has not been updated in the first model; or
the activation parameter is any one or more parameters in the first model.

6. The method according to claim 1, further comprising:
determining, by the first node, the next-hop node based on node information of each node in the node set, wherein the node information comprises one or more of: first indication information, a data feature, computing capability information, or channel state information, wherein the first indication information indicates whether a node is traversed.

7. The method according to claim 1, wherein
the next-hop node is a node that has not been traversed in the node set;
the next-hop node is a node that is in the node set and whose correlation with the data of the first node is strongest;
the next-hop node is a node that is in the node set and whose distance from the first node is shortest;
the next-hop node is a node that is in the node set and that has highest connection power to the first node;
the next-hop node is a node that is in the node set and whose computing capability is highest; or
the next-hop node is any node in the node set.

8. The method according to claim 1, wherein sending, by the first node, the updated first model to the next-hop node comprises:
when a first condition is not met, sending, by the first node, the updated first model to the next-hop node, wherein the first condition is that a quantity of times that the first node is traversed is greater than or equal to a preset quantity of epochs, or the first condition is that model prediction accuracy of the first model is greater than or equal to preset accuracy.

9. The method according to claim 8, wherein
each node in the node set is configured to update the first model in each epoch corresponding to the preset quantity of epochs.

10. The method according to claim 1, wherein sending, by the first node, the updated first model to the next-hop node comprises:
sending, by the first node, the updated first model to a plurality of next-hop nodes.

11. A communication apparatus, comprising a processor, and the processor is configured to run a computer program or instructions, to enable the communication apparatus to perform:
obtaining a first model, wherein the first node is any node in a node set, and the node set is used to train the first model;
updating the first model to obtain an updated first model, wherein the updated first model converges on the first node; and
sending the updated first model to a next-hop node, wherein the next-hop node is a node in the node set.

12. The apparatus according to claim 11, wherein updating the first model to obtain the updated first model comprises:
determining an activation parameter based on the first model, wherein the activation parameter is a part or all of parameters of the first model; and
updating the activation parameter to obtain the updated first model.

13. The apparatus according to claim 12, wherein determining the activation parameter based on the first model comprises:
determining the activation parameter based on one or more of the following: a data feature of the first node, a computing capability of the first node, or an update status of the parameters of the first model.

14. The apparatus according to claim 12, wherein
the activation parameter is a parameter that is in the parameters of the first model and whose correlation with data of the first node is greater than or equal to a preset threshold;
the activation parameter is a parameter that has not been updated in the first model; or
the activation parameter is any one or more parameters in the first model.

15. The apparatus according to claim 11, wherein the apparatus is further configured to:
determine the next-hop node based on node information of each node in the node set, wherein the node information comprises one or more of the following: first indication information, a data feature, computing capability information, or channel state information, wherein the first indication information indicates whether a node is traversed.

16. The apparatus according to claim 11, wherein
the next-hop node is a node that has not been traversed in the node set;
the next-hop node is a node that is in the node set and whose correlation with the data of the first node is strongest;
the next-hop node is a node that is in the node set and whose distance from the first node is shortest;
the next-hop node is a node that is in the node set and that has highest connection power to the first node;
the next-hop node is a node that is in the node set and whose computing capability is highest; or
the next-hop node is any node in the node set.

17. The apparatus according to claim 11, wherein sending the updated first model to the next-hop node comprises:
when a first condition is not met, sending the updated first model to the next-hop node, wherein the first condition is that a quantity of times that the first node is traversed is greater than or equal to a preset quantity of epochs, or the first condition is that model prediction accuracy of the first model is greater than or equal to preset accuracy.

18. The apparatus according to claim 17, wherein
each node in the node set is configured to update the first model in each epoch corresponding to the preset quantity of epochs.

19. The apparatus according to claim 11, wherein sending the updated first model to the next-hop node comprises:
sending the updated first model to a plurality of next-hop nodes.

20. A non-transitory computer-readable storage medium, comprising executable instructions, wherein the executable instructions, when executed by a computer, cause the computer to:
obtain a first model, wherein the first node is any node in a node set, and the node set is used to train the first model;
update the first model to obtain an updated first model, wherein the updated first model converges on the first node; and
send the updated first model to a next-hop node, wherein the next-hop node is a node in the node set.
